(19) United States
(12) Patent Application Publication
(10) Pub. No.: US 2016/0053623 A1
(43) Pub. Date: Feb. 25, 2016

(54) CONTACTLESS SEALS FOR GAS TURBINE ENGINES

(71) Applicant: United Technologies Corporation, Farmington, CT (US)

(72) Inventor: Ioannis Alvanos, West Springfield, MA (US)

(21) Appl. No.: 14/809,894

(22) Filed: Jul. 27, 2015

Related U.S. Application Data
(60) Provisional application No. 62/039,334, filed on Aug. 19, 2014.

(51) Int. Cl. F01D 11/04; F16J 15/447; F16J 15/40; F01D 11/10

(52) U.S. Cl. CPC F01D 11/04; F01D 11/10; F16J 15/447; F16J 15/40; F05D 2220/32; F05D 2240/55

(57) ABSTRACT

A seal for a gas turbine engine includes a first seal structure and a second seal structure. The first seal structure is separated from the second seal structure by a gap. The first seal structure includes an injector extending into the gap with an outlet that is in fluid communication with a fluid source. Fluid issuing from the outlet and against the second seal structure magnifies a vortex formed within the gap by fluid traversing the gap.

### CROSS-REFERENCE TO RELATED APPLICATION

This application claims the benefit of priority under 35 U.S.C. §119(e) to U.S. Provisional Application No: 62/039,334, filed Aug. 19, 2014, which is incorporated herein by reference in its entirety.

### BACKGROUND OF THE INVENTION

1. Field of the Invention

The present disclosure relates to gas turbine engines, and more particularly sealing between rotating and static gas turbine engine components.

2. Description of Related Art

Gas turbine engines generally include rotor portions, stator portions, and cavities in fluid communication with pressure differentials therebetween. Seals typically restrict fluid flow between cavities in fluid communication with one another to limit undesired fluid communication between the cavities. One type of a seal is a contactless seal. Contactless seals generally include rotating and static structures in proximity to one another separated by a gap. The proximity of the structures typically causes fluid traversing the gap to swirl immediately adjacent the gap on the low-pressure side of the seal structures. The swirl forms a localized region of high-pressure between the rotor and stator portions that discourages fluid from traversing the gap, thereby effecting sealing between the cavities.

One challenge to contactless seals is maintaining effective sealing. Generally, sealing effectiveness is a function of the gap size, i.e. the minimum distance between the stator and rotor portions. However, since engine parts can expand and contract over the engine operating cycle, there are limits to how small the gap size can be in a given engine as well as how effectively the gap size can be mechanically controlled.

Such conventional methods and systems have generally been considered satisfactory for their intended purpose. However, there is still a need in the art for improved seals. The present disclosure provides a solution for this need.

### SUMMARY OF THE INVENTION

A seal for a gas turbine engine includes a first seal structure and a second seal structure. The first seal structure is separated from the second seal structure by a gap. The first seal structure includes an injector extending into the gap with an outlet that is in fluid communication with a fluid source. Fluid issuing from the outlet and against the second seal structure magnifies a vortex formed within the gap by fluid traversing the gap.

In certain embodiments, the first seal structure can be connected to a stator portion of the gas turbine engine. The first seal structure can be connected to the rotor portion of the gas turbine engine. The first seal structure can also be defined by a disk cover connected to a disk of the rotor portion of the gas turbine engine. The injector outlet can also be communicative with a cavity disposed on a side of the disk cover opposite the gap. It is contemplated that the second seal structure can define an impingement area opposite the injector with planar contour or a contour with an arcuate profile.

In accordance with certain embodiments, the injector can define a linear channel extending between an inlet and the outlet of the channel. The linear channel can also have a cross-section with a uniform flow area along a length of the channel between the inlet and outlet. The outlet can be oriented toward a forward end of the gas turbine engine, toward an aft end of the gas turbine engine, in a direction of rotation of the rotor portion of the gas turbine engine, or in a direction opposite the direction of rotation of the rotor portion of the gas turbine engine.

It is further contemplated that in certain embodiments the seal can be a flow-discouraging seal separating the rotor portion from the stator portion. The seal can be a labyrinth seal with a first knife-edge and a second knife-edge, and the injector can be arranged between the first and second knife-edges. The first seal structure can define a first swirl region between the first and second seal structures, the first seal structure bounding a portion of the first swirl region with a contoured surface having a curvilinear profile. The first swirl region can also define a second swirl region between first and second seal structures, the first seal structure bounding a portion of the second swirl region with a contoured surface having a curvilinear profile. The curvilinear profiles bounding the first and second swirl regions can minor one another with respect to an axis defined by the injector. It is also contemplated that a gap width can be defined between the contoured surface of the first swirl region and the second seal element that is greater than a gap width defined between the contoured surface of the second swirl region and the second seal element.

A gas turbine engine includes a stator portion and a rotor portion separated by a gap. The rotor portion includes a first seal structure as described above and the stator portion includes a second seal structure as described above. The second seal structure is arranged on the stator portion opposite the first seal structure and includes an injector with an outlet extending from the first seal structure into the gap. The outlet is in fluid communication with a fluid source for issuing fluid against the second seal structure, thereby magnifying a first and second vortices within the gap and creating a third vortex within the gap

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic, partially cross-sectional side elevation view of an exemplary embodiment of a gas turbine engine constructed in accordance with the present disclosure, showing a rotor;

FIG. 2 is a cross-sectional side elevation view of the gas turbine engine of FIG. 1, showing embodiments of seals arranged between cavities with differential pressures;

FIG. 3 is cross-sectional side elevation of a first embodiment of the seals shown in FIG. 2, showing a flow discouraging seal or oriented toward a forward end of a gas turbine engine and forming a fluid curtain between adjacent cavities;

FIG. 4 is cross-sectional side elevation of a another embodiment of the seals shown in FIG. 2, showing a flow discouraging seal or oriented toward an aft end of a gas turbine engine and forming a fluid curtain between adjacent cavities; and

FIG. 5 is cross-sectional side elevation of a yet another embodiment of the seals shown in FIG. 2, showing a labyrinth seal forming duplex fluid curtains between cavities

### DETAILED DESCRIPTION OF THE PREFERRED EMBODIMENTS

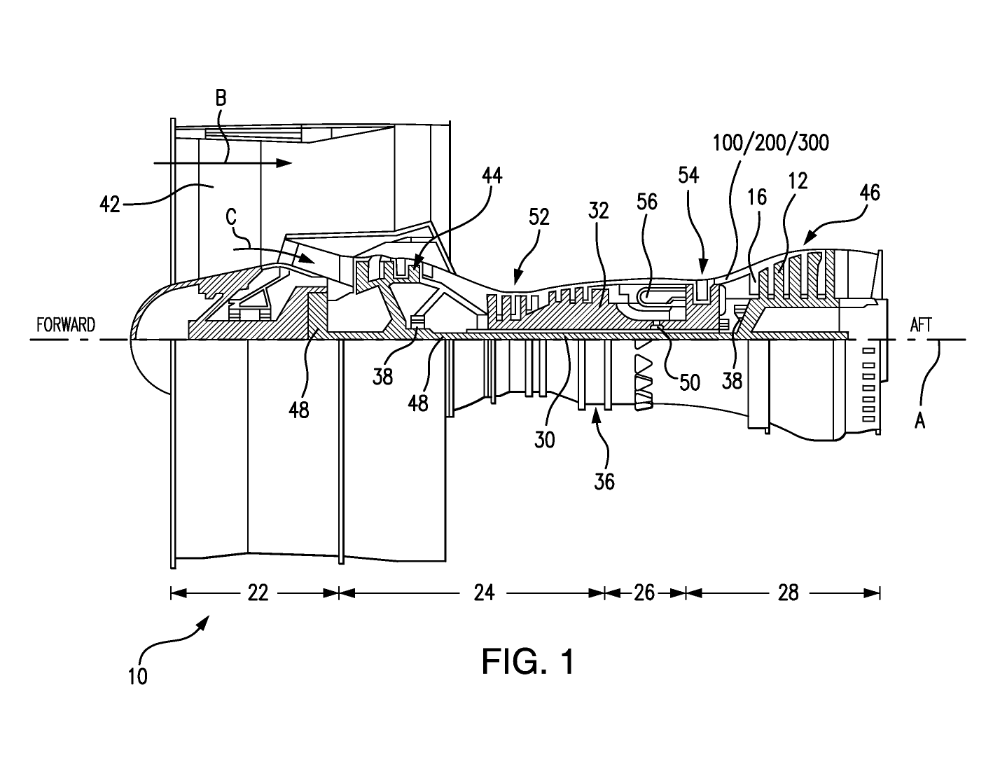

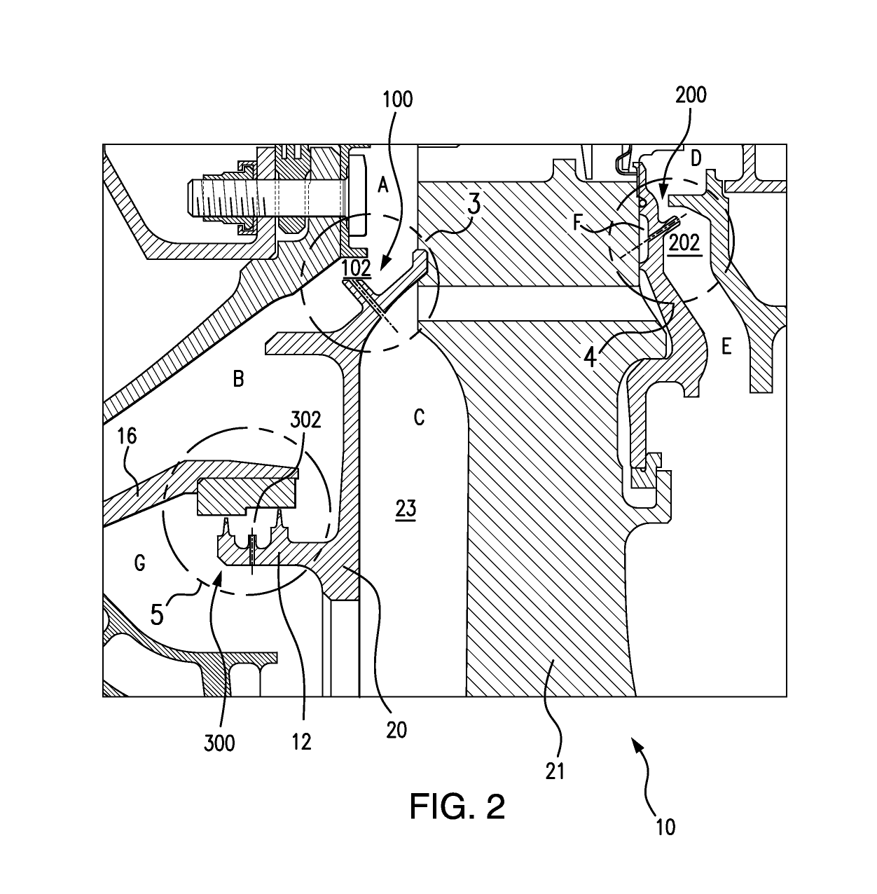

Reference will now be made to the drawings wherein like reference numerals identify similar structural features or aspects of the subject disclosure. For purposes of explanation and illustration, and not limitation, a partial view of an exemplary embodiment of a gas turbine engine with a seal in accordance with the disclosure is shown in FIG. 1 and is designated generally by reference character 10. Other embodiments of seals in accordance with the disclosure, or aspects thereof, are provided in FIGS. 2-5, as will be described. The systems and methods described herein can be used in aircraft main engines and auxiliary engines.

With reference to FIG. 1, gas turbine engine 10 is schematically shown. As described herein, gas turbine engine 10 is a two-spool turbofan engine that generally incorporates a fan section 22, a compressor section 24, a combustor section 26 and a turbine section 28. Alternative engines might include an augmentor section (not shown) among other systems or features. Fan section 22 drives air along a bypass flow path B. Compressor section 24 drives air along a core flow path C for compression and communication into combustor section 26 and subsequent expansion through turbine section 28. Although depicted as a turbofan gas turbine engine, it is to be understood and appreciated that the concepts described herein are not limited to use with turbofans as the teachings may be applied to other types of turbine engines, such as three-spool gas turbine engine architectures.

Gas turbine engine 10 generally includes a rotor portion 12 separated from a stator portion 16 by a gap 102 (shown in FIG. 2) with a seal 100 extending between rotor portion 12 and stator portion 16. Rotor portion 12 and stator portion 16 are divided into a low-speed spool 30 and a high-speed spool 32 mounted for rotation about an engine central longitudinal axis A relative to an engine static structure 36 via several bearing systems 38. It should be understood that various bearing systems 38 at various locations may alternatively or additionally be provided.

Low-speed spool 30 generally includes an inner shaft 40 that interconnects a fan 42, a low-pressure compressor 44 and a low-pressure turbine 46. Inner shaft 40 may be connected to fan 42 directly or through a geared architecture 48 to drive fan 42 at a rotation speed lower than a rotation speed of low-speed spool 30, such as with a gear reduction ratio of, for example, about at least 2.3:1. High-speed spool 32 includes an outer shaft 50 that interconnects a high-pressure compressor 52 and high-pressure turbine 54. Combustor section 26 includes a combustor 56 arranged between high-pressure compressor 52 and high-pressure turbine 54. Inner shaft 40 and outer shaft 50 are concentric and configured for rotation about engine central longitudinal axis A which is collinear with respective longitudinal axes of inner shaft 40 and outer shaft 50.

Core airflow C is compressed to by low-pressure compressor 44 and communicated to high-pressure compressor 52. High-pressure compressor 52 further compresses core airflow C and communicates core airflow C to combustor section 26. Fuel is added to core airflow C and the mixture ignited in combustor 56, core airflow C thereby undergoing further pressurization and forming combustion products. Combustor 56 communicates the combustion products forming core airflow C into high-pressure turbine 54 and low-pressure turbine 46. High-pressure turbine 54 and low-pressure turbine 46 successive expand the combustion products forming core airflow C, extract work therefrom, and rotationally drive low-speed spool 30 and high-speed spool 32. Low-speed spool 30 and high-speed spool 32 in turn rotate fan 42. Rotation of fan 42 generates bypass airflow B and provides thrust.

Gas turbine engine 10 is typically assembled in build groups or modules that form a rotor portion 12 and a stator portion 16. Stator portion 16 is separated from rotor portion 12 by at least one contactless seal, a first seal 100, second seal 200 and third seal 300 being identified in FIG. 1 for purposes of illustration and not limitation. In the illustrated embodiment, low-pressure compressor 44 includes three stages, high-pressure compressor 52 includes eight stages, high-pressure turbine 54 includes two stages, and low-pressure turbine includes five stages, respectively, stacked in an axial arrangement. It should be appreciated, however, that any number of stages will benefit herefrom. Further, other gas turbine architectures such as three-spool architecture with an intermediate spool will also benefit herefrom as well.

With reference to FIG. 2, a cross-sectional side elevation of gas turbine engine 10 is shown including first seal 100, second seal 200, and third seal 300. Rotor portion 12 and stator portion 16 define a plurality of pressurized cavities within the interior of gas turbine engine 10 (shown in FIG. 1). These pressurized cavities are physically connected by passageways that are bounded by seals. Controlling fluid flow through the passageways using the seals can have an advantageous effect on engine performance and/or reliability.

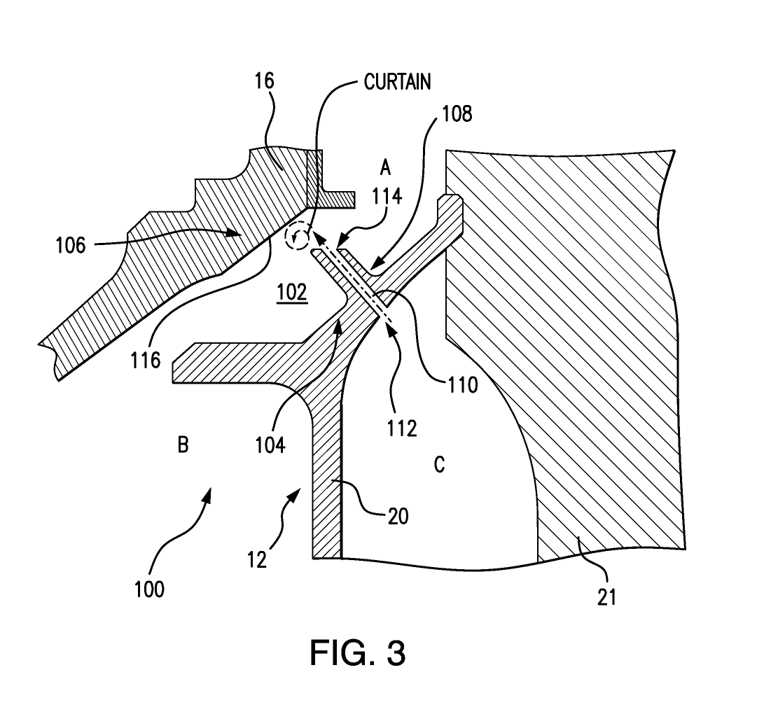

First seal 100 is arranged across a passageway 102 extending between a first cavity A and a second cavity B, and is in fluid communication with a third cavity C. First cavity A has a pressure that is less than second cavity B. Third cavity C has a pressure that is greater than both second cavity B and first cavity A. First seal 100 is configured and adapted to issue fluid into passageway 102 between first cavity A and second cavity B, thereby limiting fluid flow from first cavity A to second cavity B. This magnifies a vortex (shown in FIG. 3) formed by fluid traversing passageway 102, potentially improving sealing between cavities in fluid communication with one another through passageway 102.

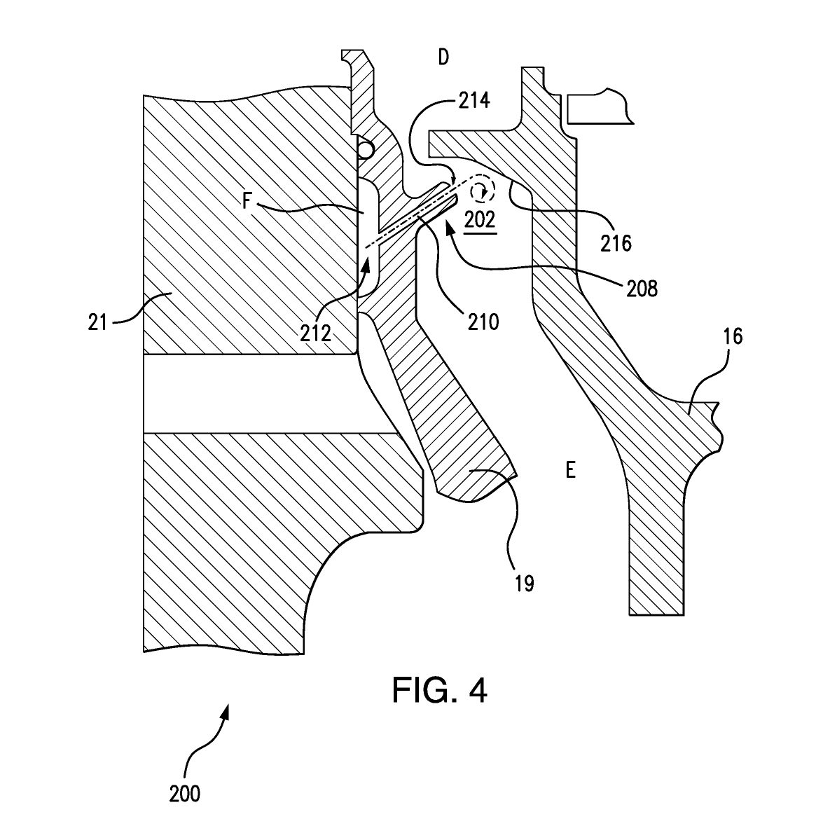

Second seal 200 is arranged across a passageway 202 extending between a fourth cavity D and a fifth cavity E and is in fluid communication with a sixth cavity F. Fourth cavity D has a pressure that is less than fifth cavity E. Sixth cavity F has a pressure that is greater than both fourth cavity D and that is less than fifth cavity E. Second seal 200 is configured and adapted for issuing fluid from cavity F into passageway 202 between fourth cavity D and fifth cavity E, thereby limiting fluid flow from fifth cavity E into fourth cavity D. This magnifies a vortex (shown in FIG. 4) formed by fluid traversing passageway 202, potentially improving sealing between cavities in fluid communication with one another through passageway 202.

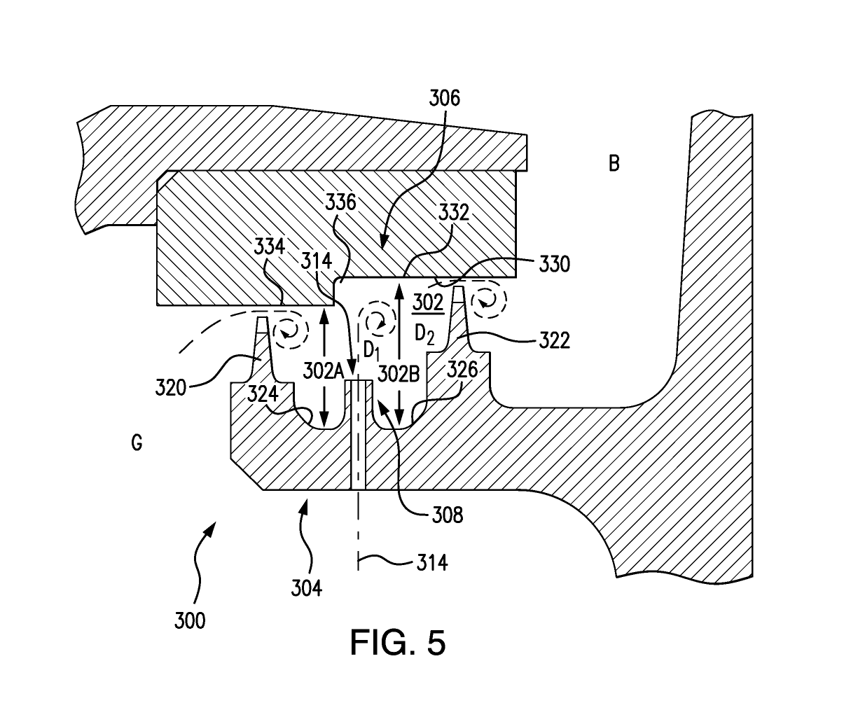

Third seal 300 is arranged across a passageway 302 extending between second cavity B and a seventh cavity G. Seventh cavity G has a higher pressure than second cavity B. Third seal 300 is configured and adapted such that fluid from seventh cavity G preferentially enters passageway 302 through third seal 300. This magnifies vortices (shown in FIG. 5) formed by fluid traversing passageway 302 and forms an additional vortex (shown in FIG. 5) within passageway 302, potentially improving sealing between cavities in fluid communication with one another through passageway 302.

With reference to FIG. 3, first seal 100 is shown. First seal 100 is a contactless, flow discouraging seal arranged between rotor portion 12 and stator portion 16. First seal 100 includes a first seal structure 104 and a second seal structure 106 that bound opposing sides of passageway 102. Passageway 102 in turn forms a gap separating rotor portion 12 from stator portion 16. Rotor portion 12 includes a disk cover 20 connected to a rotor disk 21, disk cover 20 defining first seal structure 104. Stator portion 16 defines second sealing structure 106. First seal structure 104 includes an injector 108 and is defined by rotor portion 12. As illustrated, injector 108 is defined by disk cover 20. Injector 108 in turn defines an internal channel 110 having an inlet 112 and an outlet 114 with a flow area. Channel 110 is a substantially linear channel with a uniform flow area along the length of channel 110. Channel 110 extends from third cavity C to passageway 102 and places third cavity C in fluid communication with passageway 102 through channel 110. It is to be understood and appreciated that channel 110 can have other shapes, such as a tapered flow area that decreases between the channel inlet and outlet for example, as suitable for a given application.

Outlet 114 is oriented toward a forward end of gas turbine engine 10 (shown in FIG. 1) such that fluid issuing from outlet 114 flows from outlet 114 in a direction opposing the generally flow of working fluid through gas turbine engine 10 and against second seal structure 106 opposite first seal structure 102. As illustrated, outlet 114 is communicative with third cavity C, third cavity C being disposed on a side of disk cover 20 opposite passageway 102.

Second seal structure 106 includes a surface with impingement area 116 arranged on stator portion 16 that is substantially planar and is configured and adapted to magnify a vortex formed by fluid traversing passageway 102. This increases resistance of the high-pressure vortex formed on the downstream side of passageway 102, improving the effectiveness of the vortex as a barrier to fluid traversing passageway 102. As illustrated, impingement area 116 is substantially orthogonal to channel 110. It is contemplated that impingement area 116 can be angled with respect to channel 110 so as to position or size the swirl region on a desired side of the axis of channel 110 as suitable for a given application.

With reference to FIG. 4, second seal 200 is shown. Second seal 200 includes an injector 208 with a channel 210 that extends between an inlet 212 and an outlet 214. Second seal 200 is similar to first seal 100 with at least three differences. First, an outlet 214 of second seal 200 faces toward an aft end of gas turbine engine 10 (shown in FIG. 1). Second, second seal 200 is defined by a disk cover 19 that is connected to an aft face of rotor disk 21 such that a channel 210 of second seal 200 places sixth cavity F in fluid communication with passageway 202. Finally, second seal 200 includes an impingement area 216 within an arcuate profile immediately opposite outlet 214. This directs fluid issuing from outlet 214 toward fifth cavity E, i.e. away from fourth cavity D and in the direction of increasing pressure between fifth cavity E and fourth cavity D. In this respect certain embodiments of injectors described herein create a blockage within the gap defined between rotor and stator portions of the gas turbine engine. This tends to inhibit fluid flow through the gap between the higher pressure and lower pressure regions, slowing down (or inhibiting) fluid flow therebetween.

With reference to FIG. 5, third seal 300 is shown. Third seal 300 is a labyrinth seal that includes a first seal structure 304 and a second seal structure 306. First seal structure 304 includes a first knife-edge 320, a second knife-edge 322, and an injector 308. Injector 308 is arranged between first knife-edge 320 and second knife-edge 322 within passageway 302. First knife-edge 320 is arranged on a side of injector 308 adjacent to seventh passageway G. Second knife-edge 322 is arranged on a side of injector 308 adjacent to second cavity B.

First seal structure 304 defines a first contoured surface 324 and a second contoured surface 326. First contoured surface 324 extends between injector 308 and first knife-edge 320. Second contoured surface 326 extends between injector 308 and second knife-edge 322. First contoured surface 324, opposing sides of first knife-edge 320 and injector 308, and a surface second seal structure 306 bound a first swirl region 302A disposed within passageway 302. Second contoured surface 326 mirrors first contoured surface 324 with respect to an axis defined by injector 308. Second contoured surface 326, opposing sides of second knife-edge 322 and injector 308, and the surface second seal structure 306 similarly bound a second swirl region 302B disposed within passageway 302.

Second seal structure 306 defines a surface 330. Surface 330 bounds passageway 302, a portion of first swirl region 302A, and a portion of second swirl region 302B. Surface 330 has a first segment 332, a second segment 334 offset from first segment 332 toward first seal structure 304, and a filleted segment 336 joining first segment 332 to second segment 334. The offset between first segment 332 and second segment 334 is such that a depth D1 of second swirl region 302B, i.e. the greatest distance between surface 330 and second contoured surface 32, is greater than a depth D2 of first swirl region 302A.

Conventional labyrinth seals typically define a running clearance between tips of the knife-edges and the opposing surface. This induces a pressure drop related to the running clearance. The pressure drop in turn induces vortices that form after the flow trips on the knife-edge tip, increasing the effectiveness of the sealing if the labyrinth seal. Injector 308 is configured for injecting controlled, high-pressure flow into passageway 302. The injected fluid feeds the vortices formed within the passageway, making the vortices larger after the flow trips on the knife-edge by magnifying the vortices. In embodiments, one or more additional vortices can be formed within passageway 302, potentially further improving sealing effectiveness of third seal 300.

The methods and systems of the present disclosure, as described above and shown in the drawings, provide for gas turbine engine seals with superior properties including improved sealing across engine cavities having pressure differentials. While the apparatus and methods of the subject disclosure have been shown and described with reference to preferred embodiments, those skilled in the art will readily appreciate that changes and/or modifications may be made thereto without departing from the spirit and scope of the subject disclosure. For example, first seal structure can be arranged on the stator portion of the gas turbine engine and second seal structure can be arranged on the rotor portion of the gas turbine engine. Similarly, injectors included in the first seal structure can be oriented in the direction of rotation of the rotor portion. Alternatively, the injectors can be oriented in a direction opposite the direction of rotation of the rotor portion.

What is claimed is:

1. A seal, comprising:
a first seal structure;
a second seal structure separated from the first seal structure by a gap; and
an injector with an outlet extending from the first seal structure into the gap, wherein the outlet is in fluid communication with a fluid source for issuing fluid against the second seal structure for magnifying a vortex formed within the gap by fluid traversing the gap.

2. A seal as recited in claim 1, wherein the second seal structure defines an impingement area with a planar surface opposite the outlet of the injector.

3. A seal as recited in claim 1, wherein the second seal structure defines an impingement area with an arcuate profile opposite the outlet of the injector.

4. A seal as recited in claim 1, wherein the first seal structure is connected to a rotor portion of a gas turbine engine.

5. A seal as recited in claim 4, wherein the first seal structure is defined by a disk cover connected to the rotor portion of the gas turbine engine.

6. A seal as recited in claim 5, wherein the injector outlet is communicative with a cavity disposed on a side of the disk cover opposite the gap.

7. A seal as recited in claim 1, wherein the first seal structure is defined by a stator portion of a gas turbine engine.

8. A seal as recited in claim 1, wherein the seal is a labyrinth seal with a first knife-edge and a second knife-edge, wherein the injector is arranged between the first and second knife-edges.

9. A seal as recited in claim 8, wherein the first seal structure defines a swirl region between the first and second seal structures, the first seal structure bounding a portion of the swirl region with a contoured surface having a curvilinear profile.

10. A seal as recited in claim 9, wherein the swirl region is a first swirl region, and wherein the first and second seal structure define a second swirl region, the first seal structure bounding a portion of the swirl region with a contoured surface having a curvilinear profile.

11. A seal as recited in claim 10, wherein curvilinear profiles bounding the first and second swirl regions minor one another with respect to an axis defined by the injector.

12. A seal as recited in the claim 10, wherein a gap width defined between the contoured surface of the first swirl region and the second seal element is greater than a gap width defined between the contoured surface of the second swirl region and the second seal element.

13. A seal as recited in claim 1, wherein the injector is arranged within a flow discouraging seal separating the rotor portion from the stator portion.

14. A seal as recited in claim 1, wherein the injector defines a linear channel extending between an inlet and the outlet of the channel.

15. A seal as recited in claim 14, wherein the linear channel defines a substantially uniform flow area along a length of the channel between the inlet and the outlet of the channel.

16. A seal as recited in claim 1, wherein the fluid outlet is oriented one of (a) toward a forward end of a gas turbine engine, (b) toward an aft end of gas turbine engine, (c) in a direction of rotation of a gas turbine engine rotor portion, or (d) in a direction opposite that of a direction of rotation of a gas turbine engine rotor portion.

17. A gas turbine engine, comprising:
a stator portion;
a rotor portion separated from the stator portion by a gap;
a first seal structure arranged on the rotor portion; and
a second seal structure arranged on the stator portion opposite the first seal structure, wherein the first seal structure includes an injector with an outlet extending from the first seal structure into the gap, wherein the outlet is in fluid communication with a fluid source for issuing fluid against the second seal structure, thereby magnifying a first and second vortices within the gap and creating a third vortex within the gap.

18. An engine as recited in claim 17, wherein the first seal structure includes a labyrinth seal having a first knife-edge and a second knife-edge, wherein the injector is defined between the first and second knife-edges.

19. An engine as recited in claim 18, wherein the first seal structure defines a swirl region in the gap bounded by a contoured surface with a curvilinear profile extending between the first knife-edge and the injector.

20. An engine as recited in claim 19, wherein the swirl region is a first swirl region, and wherein the first the seal structure defines second swirl region in the gap bounded by a contoured surface with a curvilinear profile extending between second knife-edge and the injector.
